(19) United States
(12) Patent Application Publication
(10) Pub. No.: US 2025/0245778 A1
(43) Pub. Date: Jul. 31, 2025

(54) VIEWPOINT IMAGE GENERATION APPARATUS, VIEWPOINT IMAGE GENERATION METHOD, AND PROGRAM

(71) Applicant: FUJIFILM Corporation, Tokyo (JP)

(72) Inventor: Hiroaki KIKUCHI, Tokyo (JP)

(73) Assignee: FUJIFILM Corporation, Tokyo (JP)

(21) Appl. No.: 19/066,117

(22) Filed: Feb. 27, 2025

Related U.S. Application Data
(63) Continuation of application No. PCT/JP2023/028672, filed on Aug. 7, 2023.

(30) Foreign Application Priority Data
Sep. 2, 2022 (JP) 2022-139998

(51) Int. Cl. G06T 3/00; G06T 7/73

(52) U.S. Cl. CPC G06T 3/00; G06T 7/74

(57) ABSTRACT

A processor of a viewpoint image generation apparatus is configured to acquire a plurality of images, acquire a position and a posture of a camera, acquire target object coordinates that are coordinates of a target object, calculate first in-camera visual field coordinates of the target object in the camera, generate observation viewpoint coordinates that are coordinates of a plurality of virtual observation viewpoints, determine an observation direction of the target object corresponding to the plurality of virtual observation viewpoints, calculate second in-camera visual field coordinates of the target object, select a transformation target image to be subjected to projective transformation, and generate a viewpoint image observed from the virtual observation viewpoint by performing the projective transformation on the transformation target image.

### CROSS-REFERENCE TO RELATED APPLICATIONS

The present application is a Continuation of PCT International Application No. PCT/JP2023/028672 filed on Aug. 7, 2023 claiming priority under 35 U.S.C § 119(a) to Japanese Patent Application No. 2022-139998 filed on Sep. 2, 2022. Each of the above applications is hereby expressly incorporated by reference, in its entirety, into the present application.

### BACKGROUND OF THE INVENTION

### 1. Field of the Invention

The present invention relates to a viewpoint image generation apparatus, a viewpoint image generation method, and a program.

### 2. Description of the Related Art

In recent years, buildings or the like on the ground have been imaged from the sky using a camera provided in a drone (an unmanned flying object). The camera provided in the drone images a building on the ground while the drone is flying. Imaging via the drone generally acquires a large number of images. A three-dimensional point cloud or an orthoimage of an object (for example, the building) is generated from the large amount of images using a three-dimensional reconstruction technique such as structure from motion (SfM) or multi view stereo (MVS).

For example, JP2020-5186A discloses a technique for generating a three-dimensional model using SfM based on an image captured by a drone.

### SUMMARY OF THE INVENTION

The point cloud obtained using such a three-dimensional reconstruction technique is advantageous in that the object such as the building can be observed from a free viewpoint and a distance from the object can be measured. However, the point cloud obtained using the three-dimensional reconstruction technique is also disadvantageous in that a resolution for detecting an abnormality (for example, damage) of the building or the like is excessively low.

The orthoimage (an orthographically projected image) that can be generated after performing three-dimensional reconstruction using the three-dimensional reconstruction technique such as SfM or MVS is advantageous in that the orthoimage can be superimposed on the map and the object is easily identified, but is also disadvantageous in that a side surface of the object cannot be observed.

The present invention has been conceived in view of such circumstances, and an object of the present invention is to provide a viewpoint image generation apparatus, a viewpoint image generation method, and a program capable of generating a viewpoint image enabling suitable observation of a side surface of a target object from an image captured by a drone or the like.

In order to achieve the object, according to a first aspect of the present invention, there is provided a viewpoint image generation apparatus comprising a processor, in which the processor is configured to acquire a plurality of images obtained by imaging a target object from different viewpoints, acquire a position and a posture of a camera that captures the plurality of images, acquire target object coordinates that are coordinates of the target object, calculate first in-camera visual field coordinates of the target object in the camera based on the position and the posture of the camera and on the target object coordinates, generate observation viewpoint coordinates that are coordinates of a plurality of virtual observation viewpoints, based on the target object coordinates, determine an observation direction of the target object corresponding to the plurality of virtual observation viewpoints, calculate second in-camera visual field coordinates of the target object in a case where the camera is disposed at the virtual observation viewpoint, based on the observation viewpoint coordinates, the observation direction, and the target object coordinates, select a transformation target image to be subjected to projective transformation from the plurality of images based on the virtual observation viewpoint and on the observation direction, and generate a viewpoint image observed from the virtual observation viewpoint by performing the projective transformation on the transformation target image based on the first in-camera visual field coordinates and on the second in-camera visual field coordinates.

According to the present aspect, the viewpoint image is generated by performing the projective transformation on the extracted transformation target image based on the first in-camera visual field coordinates and on the second in-camera visual field coordinates. Accordingly, in the present aspect, the viewpoint image with which the target object can be suitably observed from multiple viewpoints can be generated.

According to a second aspect, in the first aspect, the processor is preferably configured to extract the target object coordinates from map information of the target object.

According to a third aspect, in the first or second aspect, the map information preferably includes polygon data of the target object.

According to a fourth aspect, in any one of the first to third aspects, the projective transformation preferably includes enlarging transformation or reducing transformation.

According to a fifth aspect, in any one of the first to fourth aspects, the plurality of virtual observation viewpoints are preferably set on a circumference of a circle encompassing the target object.

According to a sixth aspect, in any one of the first to fifth aspects, the processor is preferably configured to specify the plurality of virtual observation viewpoints from a polygon coordinate group defining an external shape of the target object.

According to a seventh aspect, in the fifth aspect, a height of the circle with respect to the target object or a diameter or a radius of the circle is preferably changeable.

According to an eighth aspect, in any one of the first to seventh aspects, the transformation target image to be subjected to the projective transformation is preferably selected based on the virtual observation viewpoint, the position of the camera, the observation direction, and the posture of the camera.

According to a ninth aspect, in the eighth aspect, the processor is preferably configured to calculate a projective transformation matrix from the first in-camera visual field coordinates of at least four points and four points of corresponding second in-camera visual field coordinates, and perform the projective transformation on the transformation target image.

According to a tenth aspect, in any one of the first to ninth aspects, the processor is preferably configured to generate a new viewpoint image between the viewpoint images through interpolation based on adjacent viewpoint images.

According to an eleventh aspect, in any one of the first to tenth aspects, the processor is preferably configured to display the viewpoint image in an order of revolution around the target object.

According to a twelfth aspect, in any one of the first to eleventh aspects, the processor is preferably configured to display the viewpoint image in accordance with the virtual observation viewpoint changed in an order of revolution around the target object.

According to a thirteenth aspect, in any one of the first to twelfth aspects, the processor is preferably configured to acquire an image group including the plurality of images in which the target object is captured, and extract the plurality of images in which the target object is captured, from the image group.

According to a fourteenth aspect of the present invention, there is provided a viewpoint image generation method comprising a step of acquiring a plurality of images obtained by imaging a target object from different viewpoints, a step of acquiring a position and a posture of a camera that captures the plurality of images, a step of acquiring target object coordinates that are coordinates of the target object, a step of calculating first in-camera visual field coordinates of the target object in the camera based on the position and the posture of the camera and on the target object coordinates, a step of generating observation viewpoint coordinates that are coordinates of a plurality of virtual observation viewpoints, based on the target object coordinates, a step of determining an observation direction of the target object corresponding to the plurality of virtual observation viewpoints, a step of calculating second in-camera visual field coordinates of the target object in a case where the camera is disposed at the virtual observation viewpoint, based on the observation viewpoint coordinates, the observation direction, and the target object coordinates, step of selecting a transformation target image to be subjected to projective transformation from the plurality of images based on the virtual observation viewpoint and on the observation direction, and a step of generating a viewpoint image observed from the virtual observation viewpoint by performing the projective transformation on the transformation target image based on the first in-camera visual field coordinates and on the second in-camera visual field coordinates.

According to a fifteenth aspect of the present invention, there is provided a program for executing a step of acquiring a plurality of images obtained by imaging a target object from different viewpoints, a step of acquiring a position and a posture of a camera that captures the plurality of images, a step of acquiring target object coordinates that are coordinates of the target object, a step of calculating first in-camera visual field coordinates of the target object in the camera based on the position and the posture of the camera and on the target object coordinates, a step of generating observation viewpoint coordinates that are coordinates of a plurality of virtual observation viewpoints, based on the target object coordinates, a step of determining an observation direction of the target object corresponding to the plurality of virtual observation viewpoints, a step of calculating second in-camera visual field coordinates of the target object in a case where the camera is disposed at the virtual observation viewpoint, based on the observation viewpoint coordinates, the observation direction, and the target object coordinates, step of selecting a transformation target image to be subjected to projective transformation from the plurality of images based on the virtual observation viewpoint and on the observation direction, and a step of generating a viewpoint image observed from the virtual observation viewpoint by performing the projective transformation on the transformation target image based on the first in-camera visual field coordinates and on the second in-camera visual field coordinates.

According to the present invention, a viewpoint image with which a target object can be suitably observed from multiple viewpoints can be generated from an image captured by a drone or the like.

### BRIEF DESCRIPTION OF THE DRAWINGS

FIG. 1 is a conceptual diagram illustrating a drone for aerial imaging and a viewpoint image generation apparatus.

FIG. 2 is a block diagram illustrating an embodiment of a hardware configuration.

FIG. 3 is a functional block diagram illustrating functions of a processor.

FIG. 4 is a diagram for describing an example of a method of the aerial imaging via the drone.

FIG. 5 is a diagram illustrating an example of a plurality of captured images.

FIG. 6 is a diagram illustrating target object coordinates.

FIG. 7 is a diagram illustrating the target object coordinates.

FIG. 8 is a diagram for describing determination of an observation direction via an observation direction determination unit.

FIG. 9 is a diagram for describing an example of calculation of a projective transformation matrix.

FIG. 10 is a diagram for describing an example of calculation of the projective transformation matrix.

FIG. 11 is a diagram for describing a display example of a viewpoint image.

FIG. 12 is a diagram for describing a display example of the viewpoint image.

FIG. 13 is a flowchart illustrating a viewpoint image generation method.

FIG. 14 is a diagram for describing a captured image.

FIG. 15 is a diagram illustrating a viewpoint image generation unit.

### DESCRIPTION OF THE PREFERRED EMBODIMENTS

Hereinafter, a viewpoint image generation apparatus, a viewpoint image generation method, and a program according to a preferred embodiment of the present invention will be described with reference to the accompanying drawings.

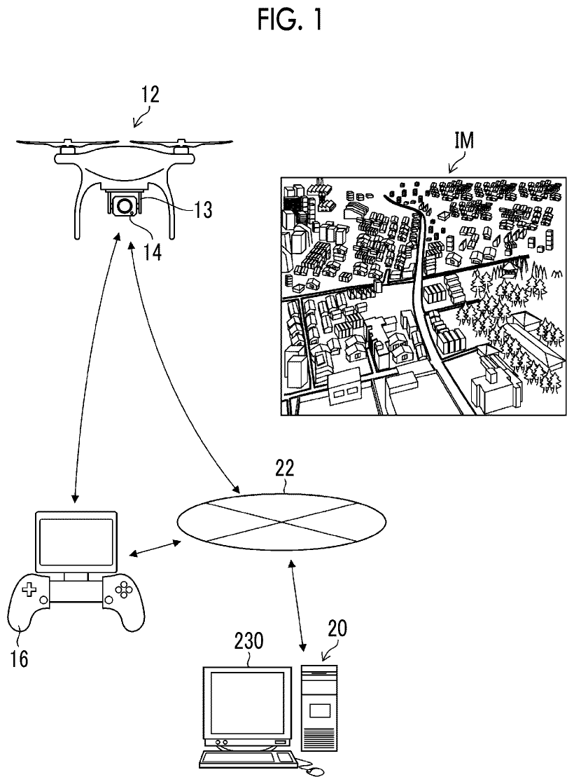

FIG. 1 is a conceptual diagram illustrating a drone for aerial imaging that images a target object according to the embodiment of the present invention, and a viewpoint image generation apparatus according to the embodiment of the present invention. FIG. 1 illustrates a case where a drone 12 and a viewpoint image generation apparatus 20 are connected by a network 22.

The drone 12 is an unmanned aerial vehicle that is remotely operated using a remote controller 16.

For example, in a case where a disaster occurs, an investigator who investigates disaster status or a drone operating person commissioned by a local government operates the drone 12 using the remote controller 16 and performs the aerial imaging of a target region (a disaster area) in which a plurality of houses are present, using a camera 14 mounted on the drone 12. Imaging via the drone 12 is not limited to a case where a disaster occurs. The aerial imaging via the drone 12 is also widely performed in other cases, and images used in the present invention also include images captured by the drone 12 in various cases.

The camera 14 is mounted on the drone 12 through a gimbal head 13.

An image (hereinafter, referred to as a “captured image IM”) captured using the camera 14 can be stored in a storage device such as an internal storage incorporated in the camera 14 and/or a memory card detachably mounted on the camera 14. The captured image IM can be transmitted to the viewpoint image generation apparatus 20 using wireless communication.

The viewpoint image generation apparatus 20 is composed of a computer. The computer applied to the viewpoint image generation apparatus 20 may be a server, a personal computer, or a workstation.

The viewpoint image generation apparatus 20 can perform data communication with the drone 12 and the remote controller 16 through the network 22. The network 22 may be a local area network or a wide area network.

The viewpoint image generation apparatus 20 can acquire the captured image IM from the drone 12 or the camera 14 through the network 22 or the remote controller 16. The viewpoint image generation apparatus 20 can acquire the captured image IM from the memory card or the like of the camera 14 without passing through the network 22. This is based on consideration of a case where a network in a part of the area is disabled because of the disaster.

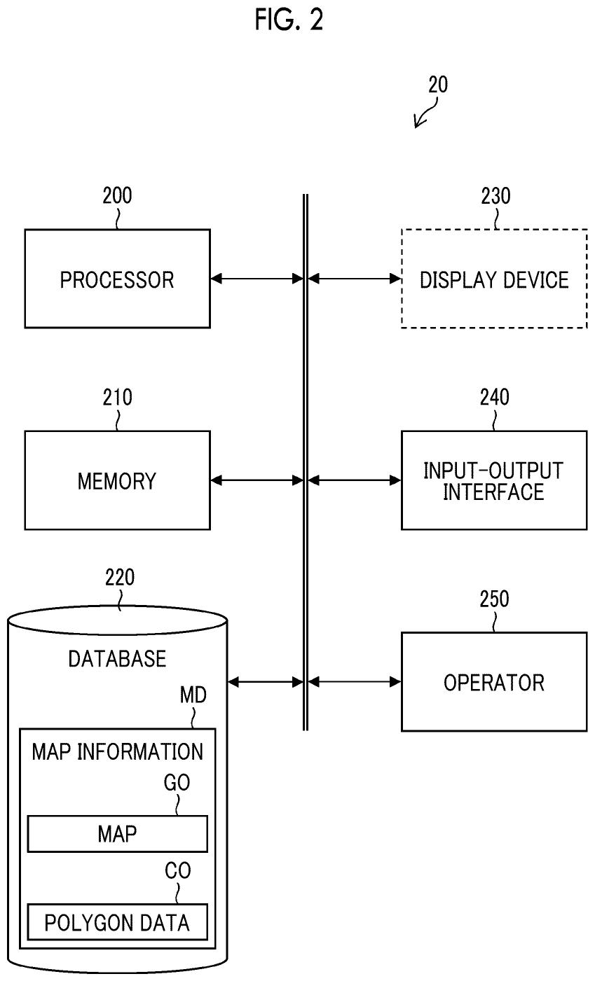

The viewpoint image generation apparatus 20 acquires a required map from an internal memory (a database 220 (refer to FIG. 2)) or an external database that provides the map. In this case, the map is a map corresponding to the captured image IM and is preferably a map including the area imaged by the captured image IM. Details of the viewpoint image generation apparatus 20, the map, and the like will be described later.

A display device 230 displays the captured image IM or displays a viewpoint image generated as described later.

FIG. 2 is a block diagram illustrating an embodiment of a hardware configuration of the viewpoint image generation apparatus 20 illustrated in FIG. 1.

The viewpoint image generation apparatus 20 illustrated in FIG. 2 comprises a processor 200, a memory 210, the database 220, the display device 230, an input-output interface 240, and an operator 250.

The processor 200 is composed of a central processing unit (CPU) and the like, performs an overall control of each unit of the viewpoint image generation apparatus 20, and performs processing of generating the viewpoint image described later and processing of displaying the generated viewpoint image on the display device 230. Details of various types of processing of the processor 200 will be described later.

The memory 210 includes a flash memory, a read-only memory (ROM), a random access memory (RAM), a hard disk device, and the like. The flash memory, the ROM, or the hard disk device is a non-volatile memory storing various programs and the like including an operation system. These programs also include a program for executing a viewpoint image generation method described later. The RAM functions as a work region of processing via the processor 200 and temporarily stores the programs and the like stored in the flash memory or the like. The processor 200 may incorporate a part (the RAM) of the memory 210.

The memory 210 functions as an image storage unit storing the captured image IM and can store and manage the captured image IM.

The database 220 is a part managing map information MD of the aerially imaged region (an area L) and, in the present example, manages a map GO and polygon data CO related to a house on the map, which are included in the map information MD.

Details of information managed by the database 220 will be described later. The database 220 may be configured in the viewpoint image generation apparatus 20 or may be an external database connected by communication. For example, the database 220 may be a database of Geospatial Information Authority of Japan managing base map information, or a database of OpenStreetMap.

The display device 230 displays the captured image IM and displays the viewpoint image in accordance with an instruction from the processor 200. The display device 230 is also used as a part of a graphical user interface (GUI) in receiving various types of information from the operator 250.

The display device 230 may be included in the viewpoint image generation apparatus 20 or may be separately provided outside the viewpoint image generation apparatus 20 as illustrated in FIG. 1.

The input-output interface 240 includes a connection unit capable of connecting to an external apparatus, a communication unit capable of connecting to a network, and the like. A universal serial bus (USB), a high-definition multimedia interface (HDMI) (HDMI is a registered trademark), or the like can be applied as the connection unit capable of connecting to the external apparatus. The processor 200 can acquire the captured image IM through the input-output interface 240 or output required information in response to a request from an outside.

The operator 250 includes a pointing device such as a mouse, a keyboard, and the like and functions as a part of the GUI that receives various types of information and instructions input through a user operation.

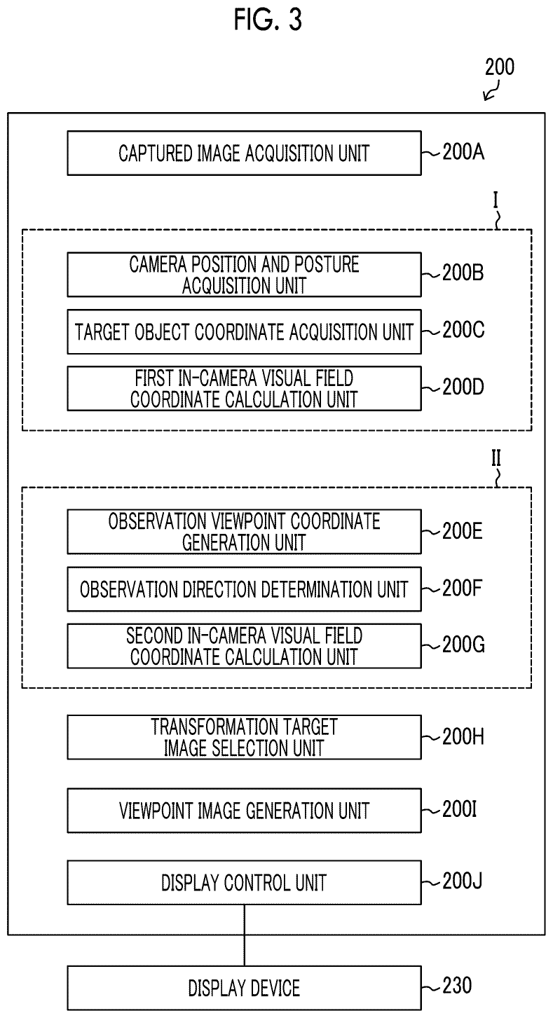

FIG. 3 is a functional block diagram illustrating functions of the processor 200 of the viewpoint image generation apparatus 20 illustrated in FIG. 2.

The processor 200 functions as a captured image acquisition unit 200A, a camera position and posture acquisition unit 200B, a target object coordinate acquisition unit 200C, a first in-camera visual field coordinate calculation unit 200D, an observation viewpoint coordinate generation unit 200E, an observation direction determination unit 200F, a second in-camera visual field coordinate calculation unit 200G, a transformation target image selection unit 200H, a viewpoint image generation unit 200I, and a display control unit 200J. First in-camera visual field coordinates are mainly calculated by a functional block group I, and second in-camera visual field coordinates are mainly calculated by a functional block group II.

### <Acquisition of Captured Image>

The captured image acquisition unit 200A acquires a plurality of captured images IM (refer to FIG. 1) captured by the camera 14 of the drone 12, from the drone 12 through the network 22. The captured image acquisition unit 200A may acquire the plurality of captured images IM from the memory card of the camera 14.

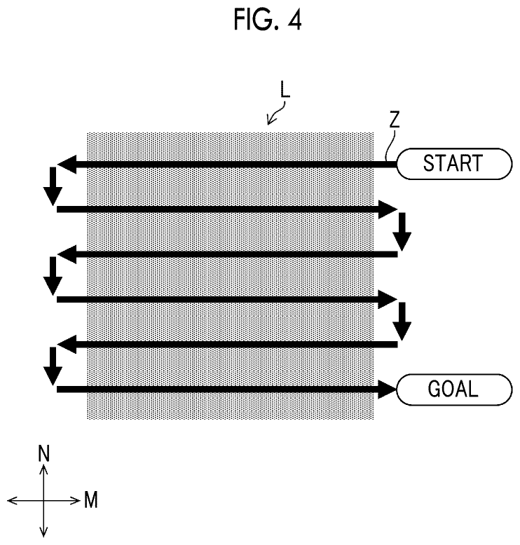

FIG. 4 is a diagram for describing an example of a method of the aerial imaging via the drone 12.

The drone 12 flies along a flying route Z and performs the aerial imaging of the area L while flying. The drone 12 acquires the plurality of captured images IM. The drone 12 images the area L through so-called horizontal grid imaging. For example, in a case where the three-dimensional reconstruction technique such as structure from motion (SfM) or multi view stereo (MVS) is used, the camera 14 of the drone 12 performs imaging such that an overlap between adjacent captured images IM (overlapping between the captured images IM in a direction M in the drawing) is approximately 75%, and performs imaging such that a side lap between adjacent captured images IM (overlapping between the captured images IM in a direction N in the drawing) is approximately 60%. Accordingly, assuming that three-dimensional reconstruction is performed using SfM or the like, the drone 12 acquires a large number of captured images IM of the area L.

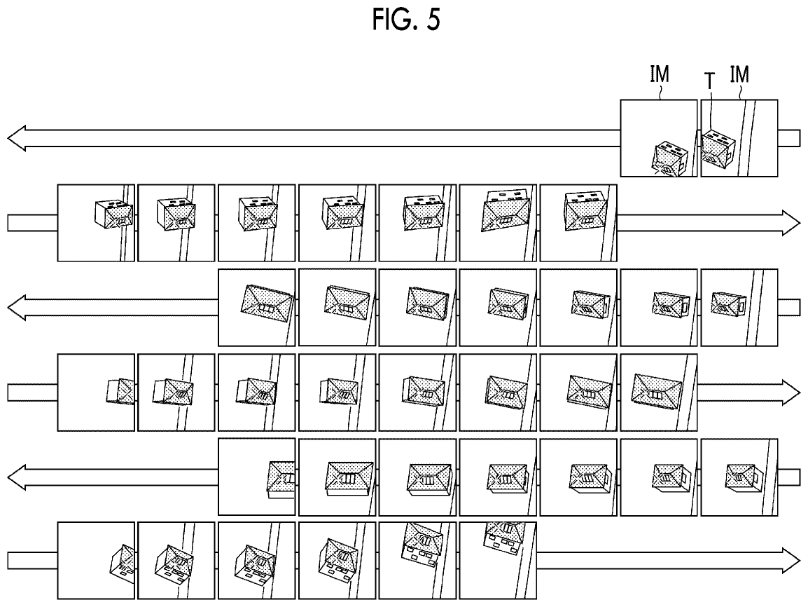

FIG. 5 is a diagram illustrating an example of the plurality of captured images IM that are the captured images IM captured by the drone 12 and that are acquired by the captured image acquisition unit 200A. In the case illustrated in FIG. 5, the captured images IM obtained by cutting out a location in which a house T that is the target object is captured are illustrated. In the present example, the captured image acquisition unit 200A acquires only the captured images IM in which the house T is captured.

The captured image acquisition unit 200A acquires the plurality of captured images IM obtained by imaging the house T, which is the target object, from different viewpoints. In the captured images IM, the house T is captured such that the house T is imaged from various imaging positions while the drone 12 is moving along the flying route Z. While the house T is captured in the captured images IM, the house T is turned upside down, or a captured wall surface of the house T is distorted, depending on the imaging position of the drone 12. Accordingly, as will be described later, in the viewpoint image generation unit 200I, the viewpoint image easily observed by a user is generated by performing projective transformation on the captured images IM.

### <Acquisition of First In-Camera Visual Field Coordinates>

First, acquisition of the first in-camera visual field coordinates will be described. The first in-camera visual field coordinates are coordinates of the house T, which is the target object, in a visual field of the camera 14 in a case where imaging is performed by the camera 14 of the drone 12.

The camera position and posture acquisition unit 200B acquires a position and a posture of the camera 14 using the captured images IM acquired by the captured image acquisition unit 200A. For example, the camera position and posture acquisition unit 200B acquires the position and the posture of the camera 14 in a case where each captured image IM is captured using SfM. In SfM, three-dimensional coordinates of the object and information (camera parameters) about a camera direction and a camera position can be acquired using a plurality of images obtained by imaging the same object from a plurality of viewpoints (camera positions). In SfM, the three-dimensional coordinates are calculated as an estimate based on a degree of displacement of the same feature point of the target object using parallax based on a motion of the camera, and the posture of the camera 14 and the position of the camera 14 in a case where each captured image IM is captured are estimated using the three-dimensional coordinates. Accordingly, the camera position and posture acquisition unit 200B acquires the position and the posture of the camera in a case where each captured image IM is captured, from the plurality of captured images IM using SfM. The camera position and posture acquisition unit 200B may calculate the position and the posture of the camera 14 via the processor 200 or may acquire the position and the posture of the camera 14 from the outside through the input-output interface 240.

The target object coordinate acquisition unit 200C acquires target object coordinates that are coordinates of the house T. The target object coordinate acquisition unit 200C can acquire the target object coordinates using various techniques. For example, the target object coordinate acquisition unit 200C extracts the target object coordinates from the map information MD of the target object stored in the database 220. The target object coordinate acquisition unit 200C may acquire the target object coordinates input from the outside through the input-output interface 240.

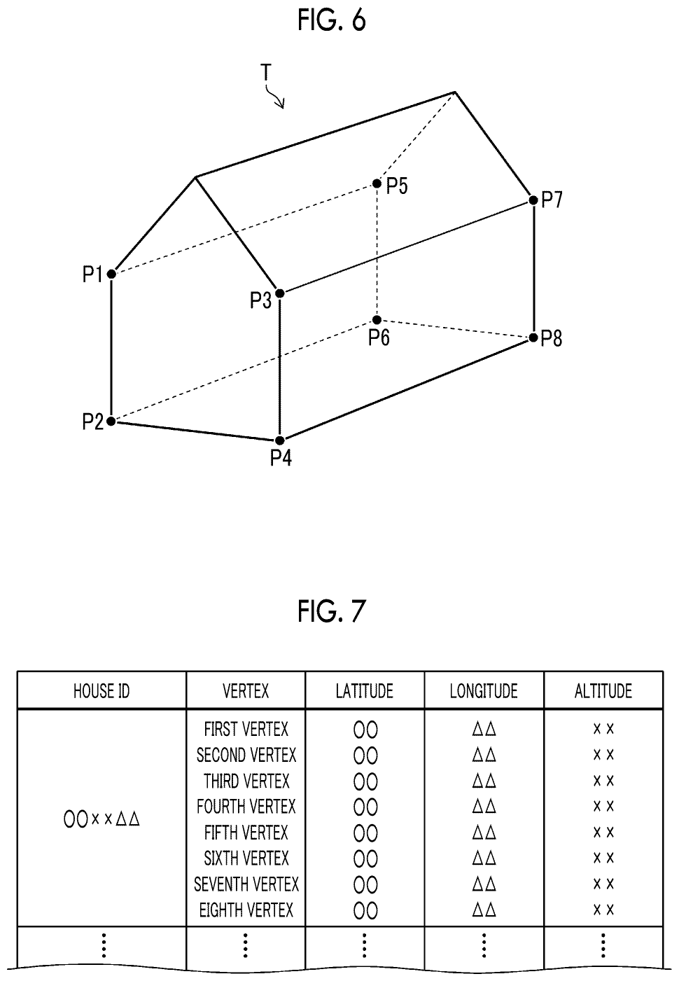

FIGS. 6 and 7 are diagrams for describing the target object coordinates.

FIG. 6 is a diagram conceptually illustrating the house T, which is the target object, and FIG. 7 is a diagram illustrating an example of the polygon data CO stored in the database 220.

World coordinates (latitude, longitude, and an altitude) of vertices P1 to P8 indicating an external shape of the house T are stored as the polygon data CO of the database 220.

The database 220 stores the polygon data CO of the house T (vertex data indicating vertices of the house T with latitude, longitude, and an altitude: a polygon coordinate group) in association with a house identification (ID) of the house T. The database 220 also has the map GO around the house T, and the map GO and the polygon data CO are associated with each other.

The polygon data CO includes vertex data P1 to P8 indicating an outer peripheral shape of the house T, and the vertex data is represented by coordinates of longitude, latitude, and an altitude indicating a position of the vertex.

In the example illustrated in FIG. 7, the polygon data CO of a house ID “ooxxΔΔ” corresponding to the house T is illustrated, and the polygon data CO related to other houses is not illustrated.

For example, the vertex data of the polygon data CO of the house ID “ooxxΔΔ” is composed of a first vertex (P1) to an eighth vertex (P8), and the first vertex to the eighth vertex are represented by three-dimensional coordinates of longitude, latitude, and an altitude. For the altitude, an altitude value corresponding to the latitude and the longitude may be acquired using a digital elevation model (DEM). While the above example describes a case where the outer peripheral shape of the house T is represented by eight vertices as the polygon data CO, the polygon data CO is not limited to eight vertices and may be composed of a plurality of vertices that can represent the outer peripheral shape of the house.

The first in-camera visual field coordinate calculation unit 200D calculates the first in-camera visual field coordinates that are coordinates of the house T in the visual field of the camera 14, based on the position and the posture of the camera 14 acquired by the camera position and posture acquisition unit 200B and on the target object coordinates acquired by the target object coordinate acquisition unit 200C. The calculated first in-camera visual field coordinates correspond in number to the target object coordinates. For example, the first in-camera visual field coordinates are calculated in accordance with P1 to P8 and are indicated as a pixel position of the image. While object coordinates obtained by transforming the longitude and the latitude into Universal Transverse Mercator (UTM) coordinates (unit: m) are used, the camera position and a virtual camera are also represented in this unified coordinate system.

The first in-camera visual field coordinate calculation unit 200D calculates first in-camera visual field coordinates x′, y′ using (Equation 1).

$$λ {( \begin{matrix}{x}^{′} \\ {y}^{′} \\ 1\end{matrix} )}_{( A 1 )} = {( \begin{matrix}{S}_{x} & 0 & {O}_{x} \\ 0 & {S}_{y} & {O}_{y} \\ 0 & 0 & 1\end{matrix} )}_{( B 1 )} {( \begin{matrix}f & 0 & 0 \\ 0 & f & 0 \\ 0 & 0 & 1\end{matrix} )}_{( C 1 )} {( \begin{matrix}1 & 0 & 0 & 0 \\ 0 & 1 & 0 & 0 \\ 0 & 0 & 1 & 0\end{matrix} )}_{( D 1 )} {( \begin{matrix}R & T \\ 0 & 1\end{matrix} )}_{( E 1 )} {( \begin{matrix}X \\ Y \\ Z \\ 1\end{matrix} )}_{( F 1 )} \qquad ( Equation 1 )$$

A matrix (A1) shows the calculated first in-camera visual field coordinates of the house T. A matrix (B1) shows a matrix for transformation into coordinates in a camera visual field of the camera 14. A matrix (C1) shows a matrix indicating a focal length of the camera 14. A matrix (D1) shows a matrix indicating perspective projection. A matrix (E1) shows a matrix for transforming the world coordinates into camera coordinates of the camera 14. A matrix (F1) shows a matrix indicating the three-dimensional coordinates (the target object coordinates) of the house T. As described above, the first in-camera visual field coordinate calculation unit 200D acquires the coordinates of the house T in the visual field for each captured image IM based on (Equation 1).

### <Second In-Camera Visual Field Coordinates>

Next, acquisition of the second in-camera visual field coordinates will be described. The second in-camera visual field coordinates are coordinates of the house T, which is the target object, in the camera visual field in a case where the camera 14 is disposed at a virtual observation viewpoint (a position of the virtual camera) and the posture of the camera 14 (a posture of the virtual camera) is directed to a virtual observation direction.

The observation viewpoint coordinate generation unit 200E generates observation viewpoint coordinates that are coordinates corresponding to a plurality of virtual observation viewpoints, based on the target object coordinates of the house T.

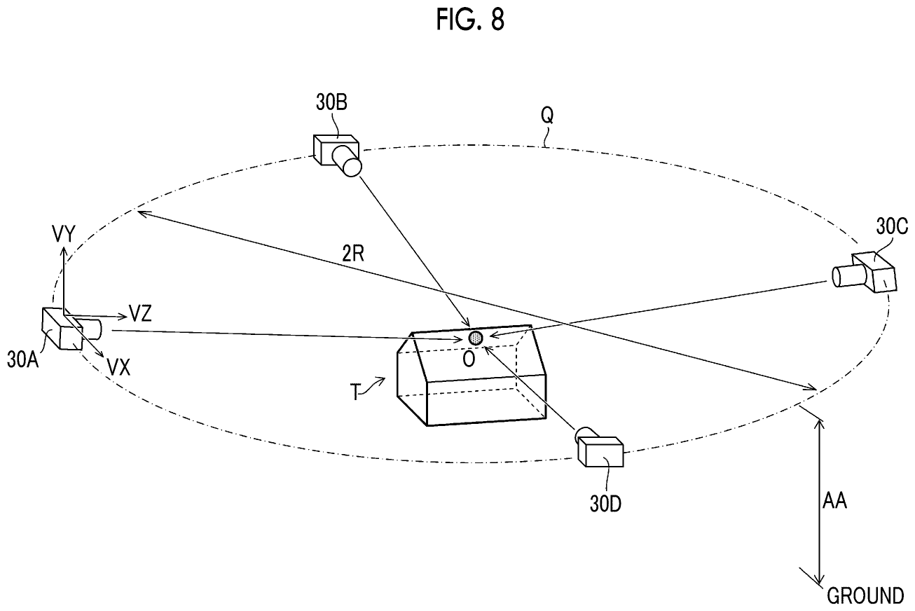

For example, the observation viewpoint coordinate generation unit 200E sets a center O of the polygon data CO (P1 to P8) of the house T or the center O of a circumscribed rectangle of the polygon data CO as (OX, OY, OZ) and sets an observation circle Q of the center O, a radius R, and a height AA from the ground (refer to FIG. 8). In a case where an imaging step angle is denoted by SA, a position (observation viewpoint coordinates) (CX, CY, CZ) of the virtual camera can be calculated using (Equation 2). The user can set any height AA and any radius R of the observation circle Q. The imaging step angle is determined in accordance with the observation viewpoint that is set by the user or automatically determined.

$$CX = R \times cos ( S A \times i ) + OX \qquad ( Equation 2 )$$

$$CY = R \times sin ( S A \times i ) + OY$$

$$CZ = A + O Z$$

In (Equation 2), i denotes an imaging number and is the same as the number of observation viewpoints.

The observation viewpoint coordinate generation unit 200E may generate the observation viewpoint coordinates based on a value input from the operator 250. For example, the user may input information related to four azimuths of east, west, south, and north or input information related to a direction of facing a road, from the operator 250, and the observation viewpoint coordinates may be generated based on an input value.

The observation direction determination unit 200F determines the observation direction of the target object corresponding to the plurality of virtual observation viewpoints. The observation direction determination unit 200F determines the observation direction based on the observation viewpoint coordinates.

FIG. 8 is a diagram for describing determination of the observation direction via the observation direction determination unit 200F.

In the case illustrated in FIG. 8, the observation circle Q of the height AA and the radius R is set to observe the house T, and virtual cameras 30A to 30D are disposed on a circumference of the observation circle Q. The observation circle Q is a circle that encompasses the house T.

A posture VZ of the virtual cameras 30A to 30D illustrated in FIG. 8 is a vector from the center O of the house T to the position of the virtual camera. A posture VX of the virtual camera illustrated in FIG. 8 is a tangent vector of the observation circle Q and is calculated from a relationship of VX·VZ=0 (an inner product). A posture VY of the camera illustrated in FIG. 8 can be obtained from an outer product of VZ and VX, and an upward (opposite to a direction of the ground) vector is adopted.

According to the above, the virtual observation viewpoint that is the position of the virtual camera is calculated as (CX, CY, CZ), and the observation direction that is the posture of the virtual camera is calculated as (VX (vector), VY (vector), VZ (vector)). While the above example illustrates a case where the virtual cameras 30A to 30D are disposed on the circumference of the observation circle Q, the present invention is not limited to this. For example, the virtual cameras 30A to 30D may be disposed on a periphery of a rectangle encompassing the target object, instead of the observation circle Q.

Parameters of the virtual camera include a focal length, a sensor size, and a pixel size of a sensor and are not physically restricted. For example, the sensor size of the parameters of the virtual camera is a parameter of a standard 35 mm full-size sensor. Any size with which the imaged house can be cut out is sufficient as the pixel size. Thus, in a case where a ground resolution of a photo is 10 cm/pixel and a physical size of the house to be cut out is 15 m, a pixel size of approximately 150 pixels is set as a design value.

A focal length f can be calculated using the parameters and the radius of the observation circle. In a case where the radius of the observation circle is 60 m, the focal length f can be calculated using (Equation 3).

$$Focal length f ( mm ) = radius R ( m ) of observation circle \times sensor size ( mm ) / cutout size ( m ) of house = 60 ( m ) \times 35 ( mm ) / 15 ( m ) = 140 ( mm ) \qquad ( Equation 3 )$$

With (Equation 3), the virtual camera can be calculated as including a lens having a focal length of 140 mm.

The second in-camera visual field coordinate calculation unit 200G calculates the second in-camera visual field coordinates based on the observation viewpoint coordinates, the observation direction, and the target object coordinates.

Specifically, the second in-camera visual field coordinate calculation unit 200G calculates first in-camera visual field coordinates x″, y″ using (Equation 4).

$$λ {( \begin{matrix}{x}^{″} \\ {y}^{″} \\ 1\end{matrix} )}_{( A 2 )} = {( \begin{matrix}{S}_{x} & 0 & {O}_{x} \\ 0 & {S}_{y} & {O}_{y} \\ 0 & 0 & 1\end{matrix} )}_{( B 2 )} {( \begin{matrix}f & 0 & 0 \\ 0 & f & 0 \\ 0 & 0 & 1\end{matrix} )}_{( C 2 )} {( \begin{matrix}1 & 0 & 0 & 0 \\ 0 & 1 & 0 & 0 \\ 0 & 0 & 1 & 0\end{matrix} )}_{( D 2 )} {( \begin{matrix}R & T \\ 0 & 1\end{matrix} )}_{( E 2 )} {( \begin{matrix}X \\ Y \\ Z \\ 1\end{matrix} )}_{( F 1 )} \qquad ( Equation 4 )$$

A matrix (A2) shows the calculated second in-camera visual field coordinates of the house T. A matrix (B2) shows a matrix for transformation into coordinates in a camera visual field of the virtual camera. A matrix (C2) shows a matrix indicating a focal length of the virtual camera. A matrix (D2) shows a matrix indicating perspective projection. A matrix (E2) shows a matrix for transforming the world coordinates into camera coordinates of the virtual camera. A matrix (F2) shows a matrix indicating the three-dimensional coordinates (the target object coordinates) of the house T. As described above, the second in-camera visual field coordinate calculation unit 200G can acquire the coordinates of the house T in the visual field at the position of each virtual camera based on (Equation 4).

### <Generation of Viewpoint Image>

Next, generation of the viewpoint image will be described. The viewpoint image is generated by performing the projective transformation on a transformation target image based on the first in-camera visual field coordinates and on the second in-camera visual field coordinates.

The transformation target image selection unit 200H selects the transformation target image to be subjected to the projective transformation from the plurality of captured images IM based on the observation viewpoint and on the observation direction. The transformation target image selection unit 200H selects the transformation target image from the captured images IM using various techniques. The transformation target image is selected in accordance with the number of observation viewpoints.

The transformation target image selection unit 200H selects the transformation target image to be subjected to the projective transformation from the plurality of captured images IM acquired by the captured image acquisition unit 200A, based on the position and the posture of the virtual camera. That is, the transformation target image selection unit 200H selects the captured image IM suitable for performing the projective transformation. For example, the transformation target image selection unit 200H selects the captured image IM for which the position and the posture of the virtual camera and the position and the posture of the camera 14 are close to each other, as the transformation target image. For example, the transformation target image selection unit 200H selects the transformation target image having a large inner product between the vector indicating the posture of the camera 14 and the vector indicating the posture of the virtual camera.

The viewpoint image generation unit 200I generates the viewpoint image observed from the virtual observation viewpoint by performing the projective transformation on the transformation target image based on the first in-camera visual field coordinates and on the second in-camera visual field coordinates. For example, the viewpoint image generation unit 200I generates the viewpoint image by calculating a projective transformation matrix from the first in-camera visual field coordinates of at least four points and the second in-camera visual field coordinates of four points and performing the projective transformation on the transformation target image. A method of calculating the projective transformation matrix from the corresponding four points via the viewpoint image generation unit 200I uses a well-known technique known as a direct linear transformation (DLT) algorithm (refer to Multiple View Geometry in computer vision, CAMBRIDGE UNIVERSITY PRESS).

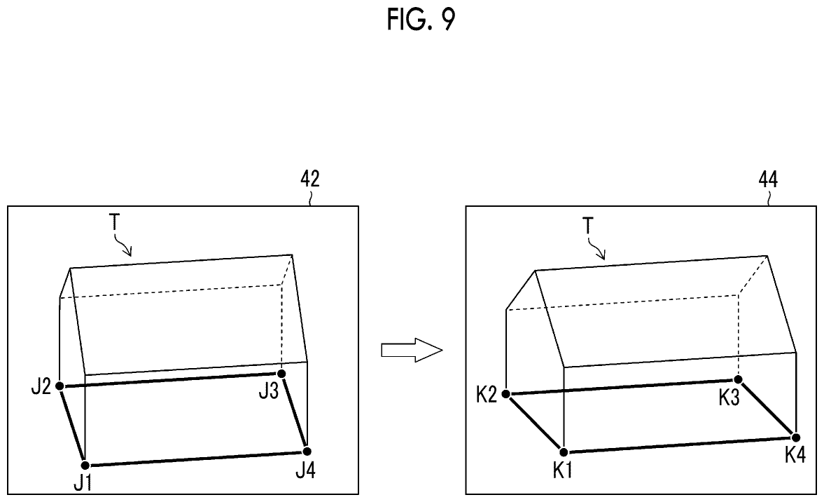

FIG. 9 is a diagram for describing an example of calculation of the projective transformation matrix. In the present example, the projective transformation matrix is calculated with reference to vertices of a rectangle formed by locations at which the house T is in contact with the ground.

A transformation target image 42 selected from the plurality of captured images IM described in FIG. 5 by the transformation target image selection unit 200H is illustrated. In the transformation target image 42, the house T which is the target object is captured, and first in-camera visual field coordinates J1 to J4 of the house T are shown. An image 44 is an image assumed to be captured by the virtual camera 30D, and second in-camera visual field coordinates K1 to K4 of the virtual camera 30D are shown on the image 44.

The viewpoint image generation unit 200I calculates a 3×3 projective transformation matrix H satisfying Ki=H×Ji (i is an integer of 1 to 4). The viewpoint image generation unit 200I generates the viewpoint image corresponding to the transformation target image 42 by applying the projective transformation matrix H to the transformation target image 42.

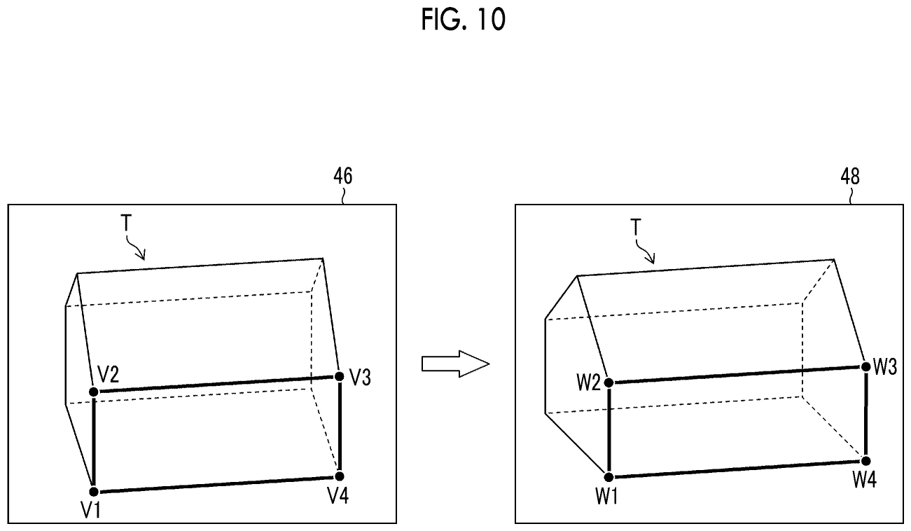

FIG. 10 is a diagram for describing another example of calculation of the projective transformation matrix. In the present example, the projective transformation matrix is calculated with reference to vertices of a rectangle constituting a wall surface of the house T.

A transformation target image 46 selected from the plurality of captured images IM described in FIG. 5 by the transformation target image selection unit 200H is illustrated. In the transformation target image 46, the house T which is the target object is captured, and first in-camera visual field coordinates V1 to V4 related to the wall surface of the house T are shown. An image 48 is an image assumed to be captured by the virtual camera 30D, and second in-camera visual field coordinates W1 to W4 of the virtual camera 30D are shown on the image 48.

The viewpoint image generation unit 200I calculates the 3×3 projective transformation matrix H satisfying Wi=H×Vi (i is an integer of 1 to 4). The viewpoint image generation unit 200I generates the viewpoint image corresponding to the transformation target image 46 by applying the projective transformation matrix H to the transformation target image 46.

As described above, the viewpoint image generation unit 200I generates the viewpoint image by calculating the projective transformation matrix from the first in-camera visual field coordinates and the second in-camera visual field coordinates of the transformation target image and transforming the transformation target image using the projective transformation matrix. The projective transformation matrix includes enlarging or reducing transformation and transformation of turning upside down.

### <Display of Viewpoint Image>

The viewpoint image generated by the viewpoint image generation unit 200I is displayed on the display device 230 by the display control unit 200J. The viewpoint image is displayed on the display device 230 in an order of revolution around the house T. Such display enables the viewpoint image of the house T at a natural viewpoint to be displayed to the user.

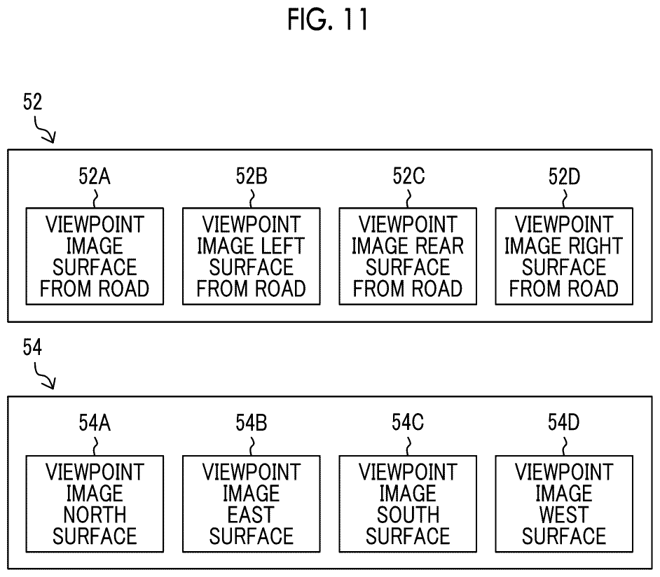

FIG. 11 is a diagram for describing a display example of the viewpoint image.

Reference numeral 52 denotes Display Example 1 of the viewpoint image. Display Example 1 illustrates an example in which a list of viewpoint images is displayed. In Display Example 1, a list of a viewpoint image 52A of a surface of the house T from the road, a viewpoint image 52B of a left surface of the house T from the road, a viewpoint image 52C of a rear surface of the house T from the road, and a viewpoint image 52D of a right surface of the house T from the road is displayed from a left end of the drawing. In this case, a direction orthogonal to the surface from the road may be detected from the polygon data of the map indicating the road and may be set as the front (the viewpoint image 52A of the surface of the house T from the road).

Reference numeral 54 denotes Display Example 2 of the viewpoint image. Display Example 2 illustrates an example in which a list of viewpoint images is displayed. In Display Example 2, a list of a viewpoint image 54A of a north surface of the house T, a viewpoint image 54B of an east surface of the house T, a viewpoint image 54C of a south surface of the house T, and a viewpoint image 54D of a west surface of the house T is displayed from the left end of the drawing.

By displaying the viewpoint image in the order of revolution around the house T (the target object), more natural display can be performed. By displaying a list of viewpoint images, the house T can be comprehensively observed.

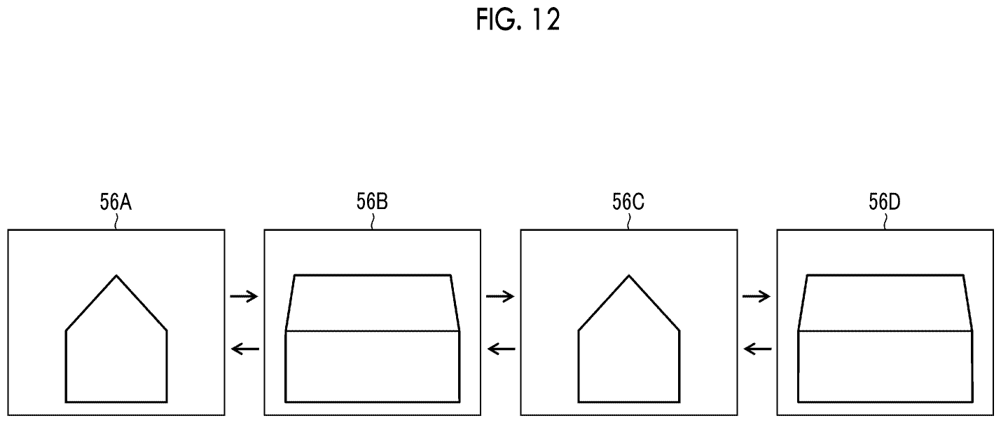

FIG. 12 is a diagram for describing a display example of the viewpoint image.

FIG. 12 illustrates Display Example 3 of the viewpoint image. In Display Example 3, the viewpoint image corresponding to each observation viewpoint is displayed on the display device 230 in accordance with the observation viewpoint changed in the order of revolution around the house T.

Specifically, the user changes the observation viewpoint to the north surface, the east surface, the south surface, and the west surface by operating the operator 250. The observation viewpoint is changed in the order of revolution around the target object. In accordance with the change, the display control unit 200J displays a viewpoint image 56A of the north surface of the house T, a viewpoint image 56B of the east surface of the house T, a viewpoint image 56C of the south surface of the house T, and a viewpoint image 56D of the west surface of the house T on the display device 230.

By displaying the corresponding viewpoint image in accordance with the viewpoint changed in the order of revolution around the house T (the target object), more natural display can be performed.

### <Viewpoint Image Generation Method>

Next, the viewpoint image generation method using the viewpoint image generation apparatus 20 will be described. For example, the viewpoint image generation method is performed by executing the program for executing the viewpoint image generation method via the processor 200 of the viewpoint image generation apparatus 20.

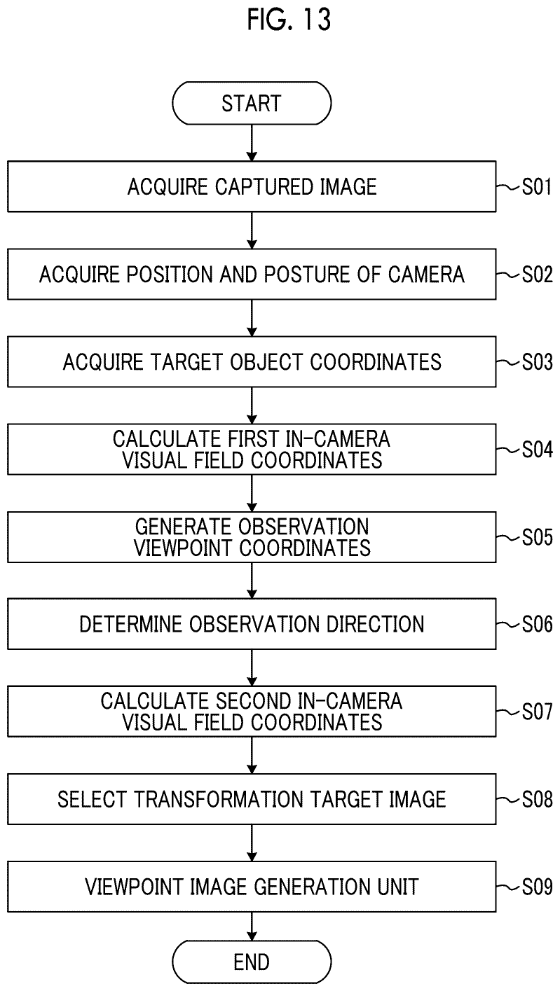

FIG. 13 is a flowchart illustrating the viewpoint image generation method using the viewpoint image generation apparatus 20.

First, the captured image acquisition unit 200A acquires the plurality of captured images IM captured by the drone 12 (step S01). Then, the camera position and posture acquisition unit 200B acquires the position and the posture of the camera 14 for each captured image IM using SfM (step S02). Then, the target object coordinate acquisition unit 200C acquires the target object coordinates (the polygon data CO) of the house T, which is the target object, from the database 220 (step S03). The first in-camera visual field coordinate calculation unit 200D calculates the first in-camera visual field coordinates of the house T based on the position and the posture of the camera 14 and on the target object coordinates of the house T (step S04).

Next, the observation viewpoint coordinate generation unit 200E sets the observation circle Q and calculates the position of the virtual camera (the observation viewpoint) based on the observation circle Q and on the number of observation viewpoints (step S05). Then, the observation direction determination unit 200F calculates the posture of the virtual camera (the observation direction) based on the observation circle Q and on the position of the virtual camera (step S06). Then, the second in-camera visual field coordinate calculation unit 200G calculates the second in-camera visual field coordinates using the position of the virtual camera (the observation viewpoint) and the posture of the virtual camera (the observation direction) (step S07). Then, the transformation target image selection unit 200H selects the transformation target image from the plurality of captured images IM acquired by the captured image acquisition unit 200A, in accordance with the number of observation viewpoints (step S08). The viewpoint image generation unit 200I generates the viewpoint image by calculating the projective transformation matrix based on the first in-camera visual field coordinates and on the second in-camera visual field coordinates and transforming the transformation target image using the projective transformation matrix (step S09).

As described above, according to the viewpoint image generation apparatus 20 of the present disclosure, a viewpoint image with which a target object can be observed from a plurality of observation viewpoints can be generated from an image captured by a drone or the like. The viewpoint image is an image obtained by performing the projective transformation on the captured images IM. Thus, deterioration in resolution from the captured images IM is suppressed, and an abnormality (for example, damage) of a building or the like can be detected. The observation viewpoint and the observation direction of the viewpoint image are suitably set. Thus, the wall surface of the house T can be suitably observed.

In the embodiment, hardware structures of processing units that execute various types of processing (the captured image acquisition unit 200A, the camera position and posture acquisition unit 200B, the target object coordinate acquisition unit 200C, the first in-camera visual field coordinate calculation unit 200D, the observation viewpoint coordinate generation unit 200E, the observation direction determination unit 200F, the second in-camera visual field coordinate calculation unit 200G, the transformation target image selection unit 200H, the viewpoint image generation unit 200I, and the display control unit 200J (refer to FIG. 3)) include various processors described below. The various processors include a central processing unit (CPU) that is a general-purpose processor functioning as various processing units by executing software (a program), a programmable logic device (PLD) such as a field programmable gate array (FPGA) that is a processor having a circuit configuration changeable after manufacture, a dedicated electric circuit such as an application specific integrated circuit (ASIC) that is a processor having a circuit configuration dedicatedly designed to execute specific processing, and the like.

One processing unit may be composed of one of the various processors or may be composed of two or more processors of the same type or different types (for example, a plurality of FPGAs or a combination of a CPU and an FPGA). A plurality of processing units may be composed of one processor. A first example of the plurality of processing units composed of one processor is, as represented by a computer such as a client and a server, one processor composed of a combination of one or more CPUs and software, in which the processor functions as the plurality of processing units. A second example is, as represented by a system on chip (SoC) and the like, use of a processor that implements functions of the entire system including the plurality processing units in one integrated circuit (IC) chip. Accordingly, various processing units are composed of one or more of the various processors as their hardware structures.

More specifically, the hardware structures of the various processors are electric circuits (circuitry) in which circuit elements such as semiconductor elements are combined.

Each configuration and each function described above can be suitably implemented by any hardware, software, or a combination of both thereof. For example, the present invention can also be applied to a program causing a computer to execute the above processing steps (a processing procedure), a computer-readable recording medium (a non-transitory recording medium) on which the program is recorded, or a computer on which the program can be installed.

### Modification Example 1

Next, Modification Example 1 will be described. In the present example, the captured image acquisition unit 200A acquires an image group acquired by the drone 12. Specifically, the captured image acquisition unit 200A acquires an image group composed of the captured images IM in which the target object is captured, and an image group composed of captured images IN in which the target object is not captured.

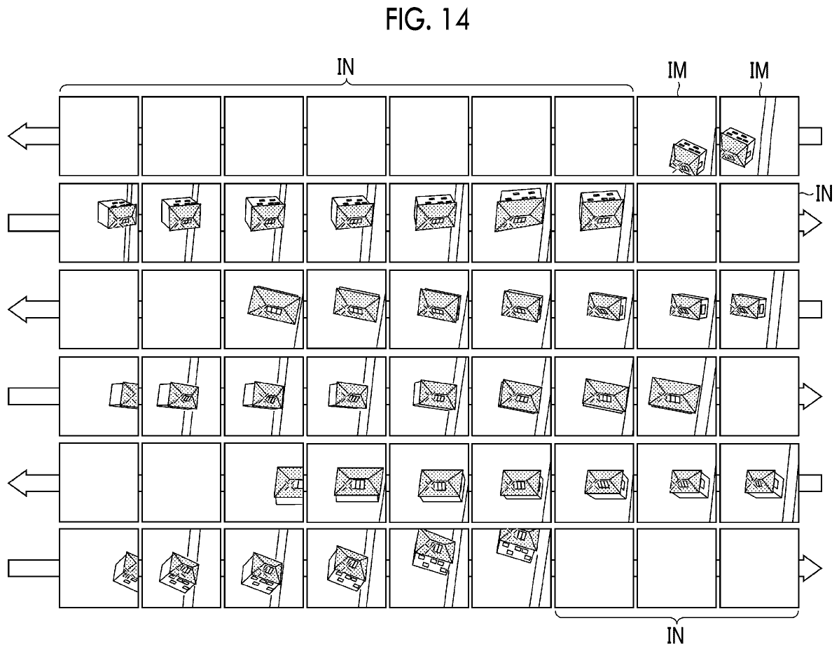

FIG. 14 is a diagram for describing the captured images acquired by the captured image acquisition unit of the present example.

The captured image acquisition unit 200A acquires a plurality of captured images IM in which the house T is captured, and a plurality of captured images IN in which the house T is not captured. For example, the drone 12 performs the aerial imaging on the flying route Z described in FIG. 4. Thus, the house T is not necessarily imaged. Thus, the captured image acquisition unit 200A first acquires all captured images captured by the drone 12 and then extracts the captured image IM in which the house T is captured.

The captured image acquisition unit 200A can extract the captured image IM in which the house T is captured, using various techniques. For example, the captured image acquisition unit 200A may determine whether or not the target object is present in the visual field of the camera 14 based on the first in-camera visual field coordinates, and in a case where the target object is present in the visual field of the camera 14, determine that the house T is captured and extract the captured image IM.

As described above, the captured image acquisition unit 200A first acquires all images acquired by the drone 12. Then, the captured image acquisition unit 200A extracts the captured image IM in which the house T is captured. Accordingly, the user does not have to select and input the captured image into the captured image acquisition unit 200A, and work can be efficiently performed.

### Modification Example 2

Next, Modification Example 2 will be described. In the present example, the viewpoint image generation unit 200I generates a new viewpoint image between viewpoint images through interpolation based on the adjacent viewpoint images.

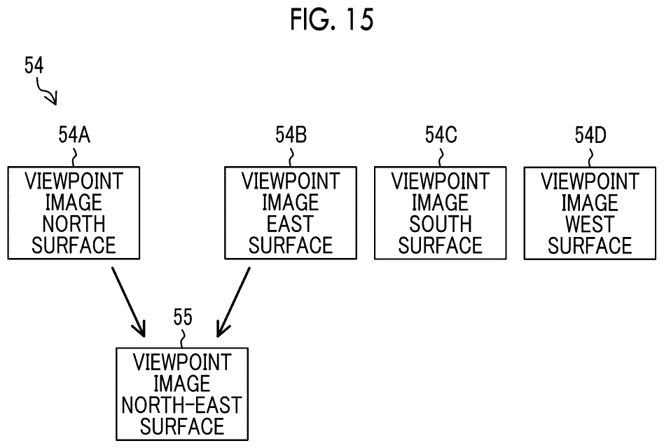

FIG. 15 is a diagram for describing the viewpoint image generation unit 200I of the present example.

As described in FIG. 11, reference numeral 54 denotes the viewpoint image 54A of the north surface of the house T, the viewpoint image 54B of the east surface of the house T, the viewpoint image 54C of the south surface of the house T, and the viewpoint image 54D of the west surface of the house T. For example, the viewpoint image generation unit 200I creates a viewpoint image 55 of a north-east surface of the house T through interpolation using the viewpoint image 54A of the north surface and the viewpoint image 54B of the east surface. Interpolation of the viewpoint image generation unit 200I uses a well-known image processing technique.

As described above, the viewpoint image generation unit 200I generates a new viewpoint image through interpolation based on the generated viewpoint images. Accordingly, the user can observe the house T from more viewpoints.

### <Other>

While the above description describes the house T as an example of the target object, the target object according to the embodiment of the present invention is not limited to the house T. For example, an artificial object such as a building or a structure other than a house, or a natural object such as a mountain or a river can also be applied as the target object.

Examples of a purpose to which the present invention is applied include creation of a disaster damage assessment document by acquiring an image of a building after a disaster occurs. The present invention is not limited to a case where a disaster occurs, and is also used for generating an image for observing a target object in other cases.

While the example of the present invention has been described above, the present invention is not limited to the embodiment and can be subjected to various modifications without departing from the gist of the present invention.

### EXPLANATION OF REFERENCES

12: drone
13: gimbal head
14: camera
16: remote controller
20: viewpoint image generation apparatus
22: network
30A: virtual camera
30B: virtual camera
30C: virtual camera
30D: virtual camera
42: transformation target image
46: transformation target image
200: processor
200A: captured image acquisition unit
200B: camera position and posture acquisition unit
200C: target object coordinate acquisition unit
200D: first in-camera visual field coordinate calculation unit
200E: observation viewpoint coordinate generation unit
200F: observation direction determination unit
200G: second in-camera visual field coordinate calculation unit
200H: transformation target image selection unit
200I: viewpoint image generation unit
200J: display control unit
210: memory
220: database
230: display device
240: input-output interface
250: operator

What is claimed is:

1. A viewpoint image generation apparatus comprising:
a processor,
wherein the processor is configured to:
acquire a plurality of images obtained by imaging a target object from different viewpoints;
acquire a position and a posture of a camera that captures the plurality of images;
acquire target object coordinates that are coordinates of the target object;
calculate first in-camera visual field coordinates of the target object in the camera based on the position and the posture of the camera and on the target object coordinates;
generate observation viewpoint coordinates that are coordinates of a plurality of virtual observation viewpoints, based on the target object coordinates;
determine an observation direction of the target object corresponding to the plurality of virtual observation viewpoints;
calculate second in-camera visual field coordinates of the target object in a case where the camera is disposed at the virtual observation viewpoint, based on the observation viewpoint coordinates, the observation direction, and the target object coordinates;
select a transformation target image to be subjected to projective transformation from the plurality of images based on the virtual observation viewpoint and on the observation direction; and
generate a viewpoint image observed from the virtual observation viewpoint by performing the projective transformation on the transformation target image based on the first in-camera visual field coordinates and on the second in-camera visual field coordinates.

2. The viewpoint image generation apparatus according to claim 1,
wherein the processor is configured to extract the target object coordinates from map information of the target object.

3. The viewpoint image generation apparatus according to claim 2,
wherein the map information includes polygon data of the target object.

4. The viewpoint image generation apparatus according to claim 1,
wherein the projective transformation includes enlarging transformation or reducing transformation.

5. The viewpoint image generation apparatus according to claim 1,
wherein the plurality of virtual observation viewpoints are set on a circumference of a circle encompassing the target object.

6. The viewpoint image generation apparatus according to claim 5,
wherein the processor is configured to specify the plurality of virtual observation viewpoints from a polygon coordinate group defining an external shape of the target object.

7. The viewpoint image generation apparatus according to claim 5,
wherein a height of the circle with respect to the target object or a diameter or a radius of the circle is changeable.

8. The viewpoint image generation apparatus according to claim 1,
wherein the transformation target image to be subjected to the projective transformation is selected based on the virtual observation viewpoint, the position of the camera, the observation direction, and the posture of the camera.

9. The viewpoint image generation apparatus according to claim 8,
wherein the processor is configured to calculate a projective transformation matrix from the first in-camera visual field coordinates of at least four points and four points of corresponding second in-camera visual field coordinates, and perform the projective transformation on the transformation target image.

10. The viewpoint image generation apparatus according to claim 1,
wherein the processor is configured to generate a new viewpoint image between the viewpoint images through interpolation based on adjacent viewpoint images.

11. The viewpoint image generation apparatus according to claim 1,
wherein the processor is configured to display the viewpoint image in an order of revolution around the target object.

12. The viewpoint image generation apparatus according to claim 1,
wherein the processor is configured to display the viewpoint image in accordance with the virtual observation viewpoint changed in an order of revolution around the target object.

13. The viewpoint image generation apparatus according to claim 1,
wherein the processor is configured to:
acquire an image group including the plurality of images in which the target object is captured; and
extract the plurality of images in which the target object is captured, from the image group.

14. A viewpoint image generation method comprising:
acquiring a plurality of images obtained by imaging a target object from different viewpoints;
acquiring a position and a posture of a camera that captures the plurality of images;
acquiring target object coordinates that are coordinates of the target object;
calculating first in-camera visual field coordinates of the target object in the camera based on the position and the posture of the camera and on the target object coordinates;
generating observation viewpoint coordinates that are coordinates of a plurality of virtual observation viewpoints, based on the target object coordinates;
determining an observation direction of the target object corresponding to the plurality of virtual observation viewpoints;
calculating second in-camera visual field coordinates of the target object in a case where the camera is disposed at the virtual observation viewpoint, based on the observation viewpoint coordinates, the observation direction, and the target object coordinates;
selecting a transformation target image to be subjected to projective transformation from the plurality of images based on the virtual observation viewpoint and on the observation direction; and
generating a viewpoint image observed from the virtual observation viewpoint by performing the projective transformation on the transformation target image based on the first in-camera visual field coordinates and on the second in-camera visual field coordinates.

15. A non-transitory, computer-readable tangible recording medium on which a program for causing, when read by a computer, the computer to execute the viewpoint image generation method according to claim 14 is recorded.
